(19) United States
(12) Patent Application Publication
(10) Pub. No.: US 2005/0102416 A1
(43) Pub. Date: May 12, 2005

(54) Modifications of tcp/ip

(76) Inventor: Richard Matthew Miller-Smith, Lingfield (GB)

Correspondence Address: PHILIPS INTELLECTUAL PROPERTY & STANDARDS, P.O. BOX 3001, BRIARCLIFF MANOR, NY, 10510, US

(21) Appl. No.: 10/504,137

(22) PCT Filed: Jan. 29, 2003
(86) PCT No.: PCT/IB03/00277

(30) Foreign Application Priority Data
Feb. 15, 2002 (GB) 0203598.8
Sep. 6, 2002 (GB) 0220705.8

(51) Int. Cl. G06F 15/173

(52) U.S. Cl. 709/238; 709/203

(57) ABSTRACT

A router at the head-end of the broadest system or mobile network caches all TCP/IP packets that pass. The router periodically resends any data packets, from its cache, which are not received at the client. The system allows TCP/IP to be easily implemented without causing significant amounts of back traffic being generated, while maintaining the same interfaces.

This invention relates to a method of and system for routing data packets, and to apparatus for transmitting data packets and to apparatus for receiving data packets.

Many Internet applications use the TCP/IP protocol to communicate. TCP/IP is designed for cable-based inter-connected networks. Advances in technology are now taking such Internet applications into other devices, e.g. digital televisions and mobile phones. These devices are connected to the Internet by other means, e.g. a broadcast television network, or a wireless telecom link.

TCP/IP has disadvantages when used on broadcast or wireless networks. For example, TCP/IP requires acknowledgement of data packets received to be signalled via the network at regular intervals. This has a number of drawbacks, as it can be expensive transmitting data in this way from a mobile phone, and/or can create too much data traffic from the large number of devices.

It is an object of the invention to overcome these disadvantages.

According to a first aspect of the invention, there is provided a method of routing data packets comprising receiving a plurality of data packets from a server, caching those data packets that are TCP/IP packets, transmitting said plurality of data packets to a client, and transmitting an acknowledgement of the receipt of said TCP/IP packets to said server.

Advantageously, the method further comprises retransmitting any cached TCP/IP packets upon request from the client.

Preferably, the method comprises, if no data or acknowledgement is received from the client, sending an acknowledgement to ensure that further data packets are sent to the router.

The method may include accepting any negative acknowledgement packets from the client and resending the data packets from the data packet cache.

Also, the method may include sending the missing data packets
(i) when a connection has been closed and there are outstanding data packets; and/or
(ii) when the list of missing packets is full; and/or
(iii) when the data packet cache is nearly full.

The present invention also provides a computer program product directly loadable into the internal memory of a digital computer, comprising software code portions for performing the steps of a method according to the present invention when said product is run on a computer.

The present invention also provides a computer program for performing the steps of a method according to the present invention.

The present invention also provides electronic distribution of a computer program product or a computer program according to the present invention.

According to a second aspect of the invention, there is provided a system for routing data packets comprising a router for receiving and transmitting data packets and a client for receiving said data packets, said router arranged to cache those data packets that are TCP/IP packets and to transmit an acknowledgement of the receipt of said TCP/IP packets.

Advantageously, the router comprises means to retransmit any cached TCP/IP packets from the client.

Preferably, the router comprises means to send an acknowledgement to a server if no data or acknowledgement is received from the client, thereby to ensure that further data packets are sent to the router.

The router may include receiving means to accept any negative acknowledgement packets from the client and transmitting means to resend the data packets from the data packet cache.

Also the transmitting means may operate:
(i) when a connection has been closed and there are outstanding data packets;
(ii) when the list of missing packets is full; and/or
(iii) when the data packet cache is nearly full.

According to a third aspect of the invention, there is provided apparatus for transmitting data packets comprising receiving means for receiving a plurality of data packets, storage means for caching those data packets that are TCP/IP packets, and transmitting means for transmitting said data packets and for transmitting an acknowledgement of the receipt of said TCP/IP packets.

Advantageously, the apparatus comprises means to retransmit any cached TCP/IP packets upon request from the client.

Preferably, the apparatus comprises means to send an acknowledgement to a server if no data packet or acknowledgement is received from a client, thereby to ensure that further data packets are sent to the router.

The apparatus may include means to accept any negative acknowledgement packets from the client and transmitting means to resend the data packets from the data packet cache. Also, the apparatus may inclusive transmitting means which operates:
(i) when a connection has been closed and there are outstanding data packets;
(ii) when the list of missing packets is full; and/or
(iii) when the data packet cache is nearly full.

According to the fourth aspect of the invention, there is provided apparatus for receiving data packets comprising receiving means for receiving data packets, processing means for identifying TCP/IP packets, storage means for storing a list of missing TCP/IP packets, and transmitting means for transmitting periodically said list of missing TCP/IP packets.

Advantageously, the processing means is achieved in software, and communicates with the operating system of the apparatus.

Preferably, the transmitting means operates:
(i) when a connection has been closed and there are outstanding data packets; and/or
(ii) when the list of missing packets is full; and/or
(iii) when the data packet cache is nearly full.

Owing to the invention, TCP/IP can easily be implemented in broadcast and wireless networks, without a large amount of back traffic being generated. From an application perspective, it is possible to maintain the same interfaces. Moreover, no modifications to user operating systems are required, so that it is possible to use the operating system's networking libraries so as to assure compatibility with current code.

The present invention ensures a substantially improved and enhanced utilization of a half-duplex network, when the traffic is primarily unidirectional.

Moreover, the number of packets back from the client device is reduced on a typical channel. Accordingly, this produces a reduction in network and radio bandwidth congestion and may provide reduced costs especially when charges are on a per-unit basis.

Embodiments of the invention will now be described, by way of example only, with reference to the accompanying drawings, in which:—

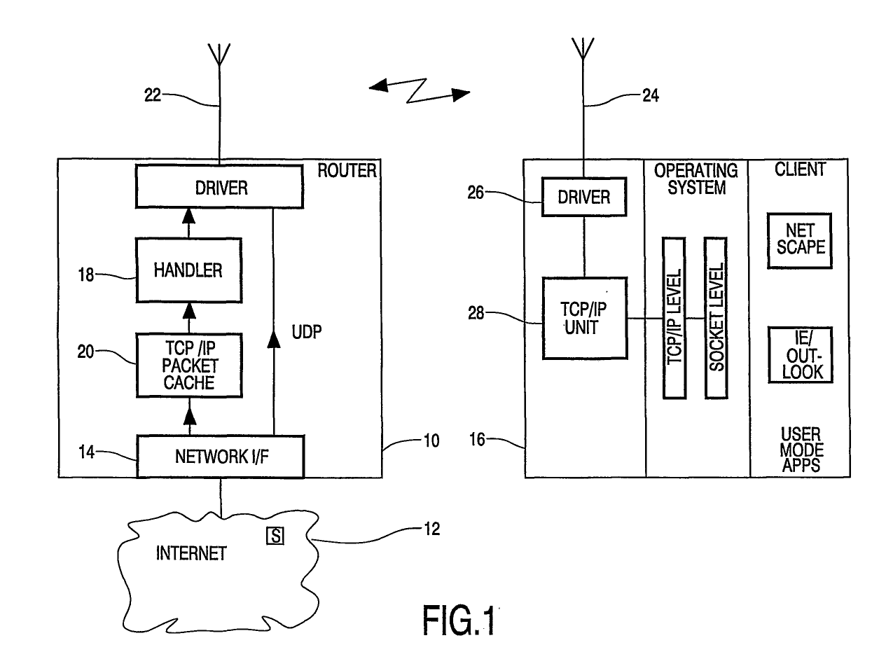

FIG. 1 is a schematic diagram of a router and a client;

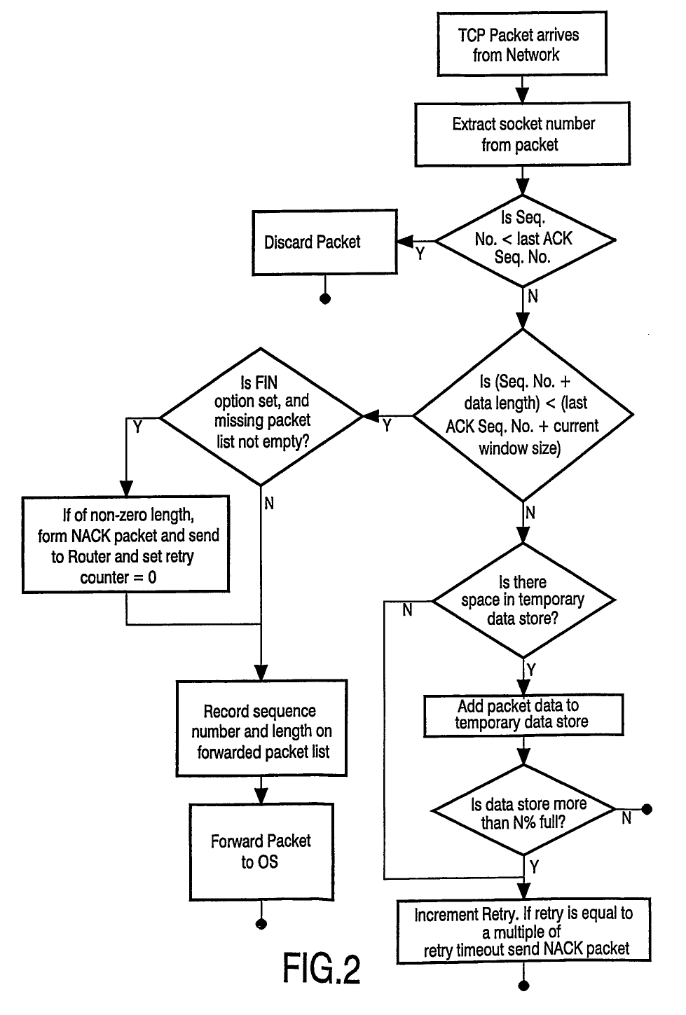

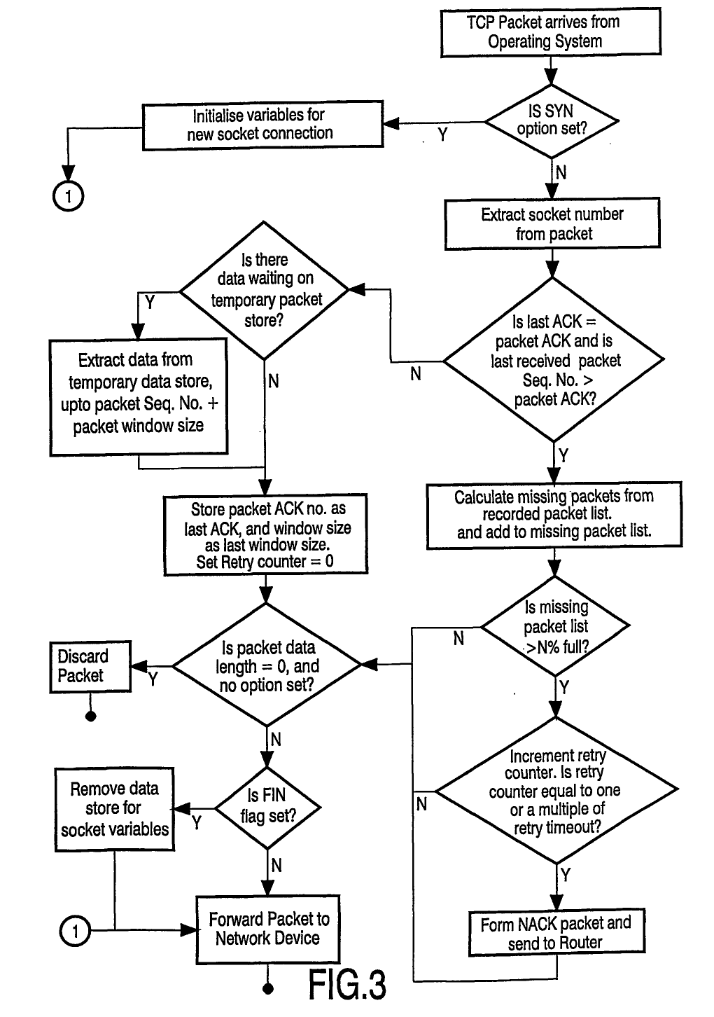

FIGS. 2 and 3 are program flow diagrams inside the driver;

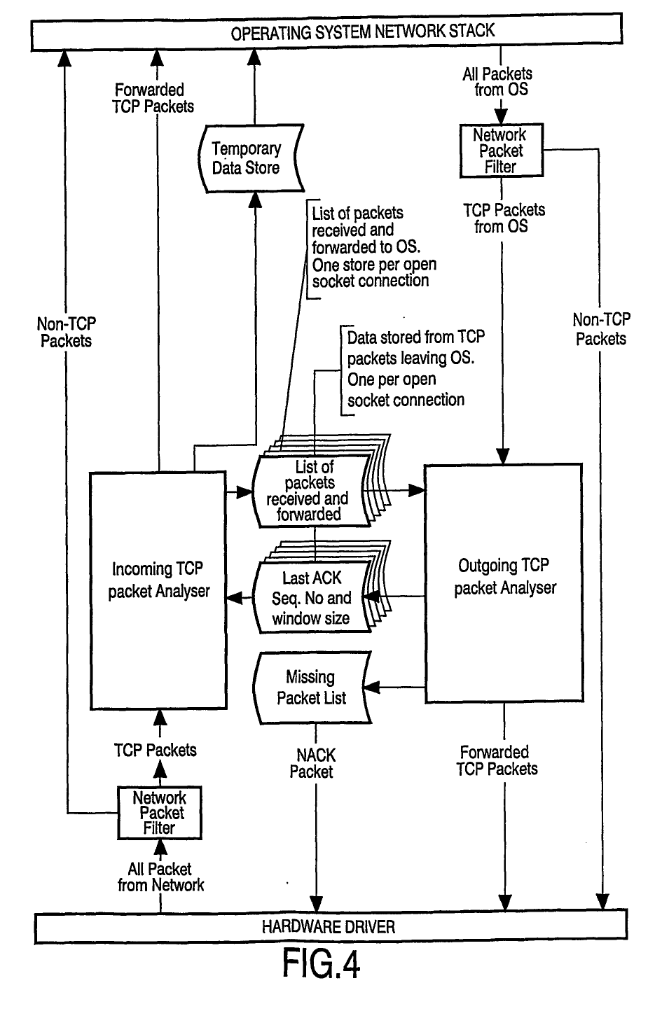

FIG. 4 shows the TCP/IP unit;

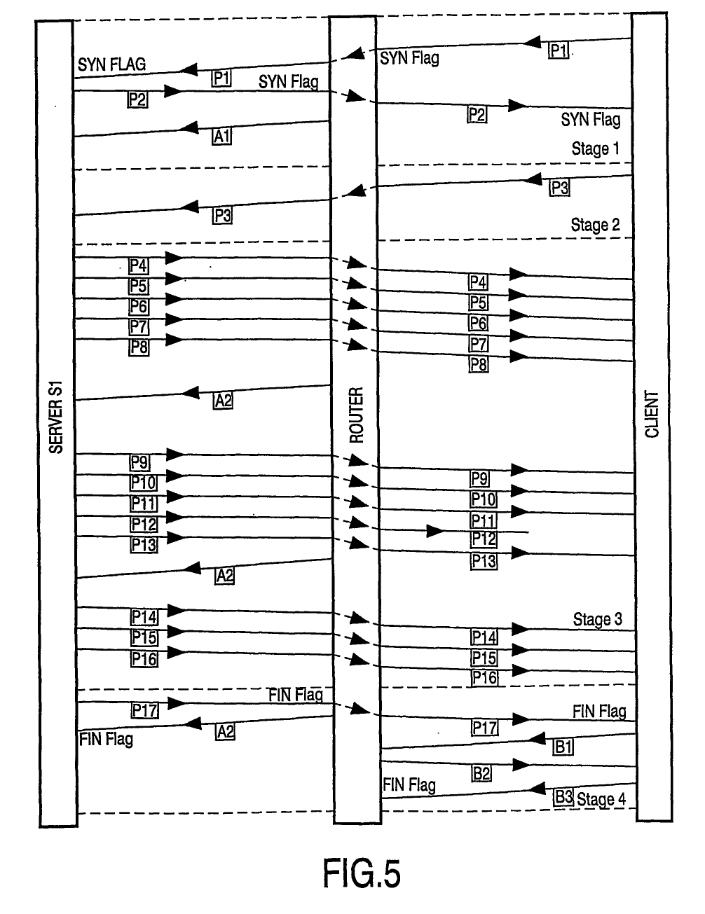

FIGS. 5 to 7 show packet flows in the system.

The invention is in two parts, firstly there is a router at the head-end of the broadcast router whereby packets pass through this system to connect the network to the rest of the internet. The second part of the system is low-level software within the client device. This sits between the hardware driver and the operating systems network level.

The router acts differently from a standard router. It caches all TCP/IP packets that it passes through. If no data or acknowledgement has come from the client, then it sends an acknowledgement (ACK) to the internet server, S, in order to ensure it continues to send data. This data is sent onward to the client. The router then accepts any negative acknowledgement (NACK) packets from the client, resending the data from the packet cache. Once the connection has been closed for a specific period of time, and no NACK packets have come from the client, all packets cached for that particular connection are removed from the cache.

The TCP/IP unit, present in the client, acts to strip out the TCP/IP packets for a connection. It then uses the TCP/IP sequence numbers and ACK data automatically generated by the operating system to keep a list of missing packets. This list of missing packets is sent to the router, either when the connection has been closed and there are outstanding packets (this will be resent, after a timeout), the list of missing packets in full, or the store of packets is nearly full.

In FIG. 1, a router 10 is connected by its network interface 14 via the internet 12 to a server S. Upon request of a client 16, which may be a mobile phone, the router 10 downloads material from the server S. The material comprises data packets, which may be a mixture of TCP/IP and UDP packets. The UDP packets are not connection based hence they are just streamed through with no intelligent handling.

However, TCP is a connection-based network. The handler 18, within the client 10, tracks which packets belong to which connection through the IP address and socket values in the TCP headers. The handler 18 also has to handle the ACK and NACK signals received from client 16.

The principle of the method of routing the data packets comprises receiving a plurality of data packets from the server S, caching those data packets that are TCP/IP packets in storage means 20, transmitting the data packets to the client 16 and transmitting an acknowledgement of the receipt of the TCP/IP packets to the server S.

The router 10 transmits the data packets to the client 16 via an aerial 22. The client 16 receives the data packets via its aerial 24. The packets travel through a hardware driver 26 to the TCP/IP unit 28. Packets are either transferred as raw IP packets, or can be encapsulated in Ethernet packets. The unit 28 can handle both types of packet. The unit passes the data packets to the operating system and stores the ACK data generated by the operating system. The ACK data is generated automatically according to the TCP protocol. This ACK data is used by the unit 28 to keep a list of missing packets. Periodically the client 16 transmits the list of missing packets to the router 10, which retransmits the TCP/IP packets requested from its cache 20.

The system of routing data packets comprises the router 10 for receiving and transmitting data packets and the client 16 for receiving said data packets. The router 10 is arranged to cache those data packets that are TCP/IP packets and to transmit an acknowledgement of the receipt of said TCP/IP packets back to the source of the packets.

By caching the packets at the router 10 and sending the ACK data from the router 10, the system effectively mimics the normal operating of handling of TCP/IP data packets. The server S functions in its normal manner. If any data is lost or corrupted between the router 10 and client 16, the client 16 is aware of this through the operation of the TCP/IP unit 28.

The unit 28 builds up a list of missing packets and periodically sends the list to the router 10, which resends the missing packets from its cache 20. Because the unit is separate and additional to the normal operating system of the client device 16, that operating system and any browser above it, again functions exactly as if a normal TCP/IP protocol data handling is in place.

The apparatus for receiving the data packets comprises receiving means (the driver 26) for receiving data packets and processing means (the unit 28) for identifying TCP/IP packets. Additionally, storage means for storing a list of missing TCP/IP packets is provided integrally with the unit 28. The driver 26 also acts as transmitting means for transmitting periodically the list of missing TCP/IP packets.

FIG. 4 shows in more detail the TCP/IP unit 28 that sits between the driver 26 and the operating system of the client.

Router

Router 10 sits between the client 16 and the internet 12. On all but TCP connections, router 16 merely forwards packets. On TCP connections, router 10 extracts information from the header in packets coming from the client and then forwards them. All packets targeted at a particular connection on the client are cached and then forwarded to the client.

As far as an internet server S is concerned, any connection between it and the client 16 which pass through the router 10 complies with the TCP standard.

Any TCP packet that is received by the router 10 is associated to a client 16 and on that client it is associated to a particular connection (through the port number in the TCP header).

The router 10 reads the maximum window size by analysing the packets leaving the client. When the router 10 has received an amount of data on that connection equal to this window size, the router 10 creates a TCP packet of zero data length, which acknowledges receipt of all the contiguous data received thus far. Similarly, if no data has been received from the internet server S or the client 16 for a short period (which is a setting on the router, but must be less than 500 ms) then a TCP packet of zero data length, which acknowledges receipt of the data, is created. These acknowledgement packets are sent to the internet server S.

The router has to spot any packets coming from the client 16 which have the synchronise (SYN) flag set. These cause the router 10 to initialise the data elements and storage required for a new TCP link. Any packet coming from the internet 12 with the SYN flag set is forwarded to the client. At this point a timeout is set, such that if no packet is seen in reply from the client 16 within a certain period, then the packet (containing the SYN flag) is resent. This will happen up to a set maximum number of times (this being done in case this packet is lost between router and client).

If a packet is dropped on the internet 16, router 10 acts as a TCP client and repeatedly sends packets with an ACK sequence number equal to the first byte of the missing data. The internet server S then resends this data. The server stores the last ACK value sent in any packet to the internet server S.

Packets from the client 16 are analysed by the router 10. Any packet that has an ACK value less than the ACK value sent on the internet to S is patched so that this ACK value is equal to the last ACK value sent.

If router 10 receives a packet from the client 16 with an ACK value, the client 16 can purge the packet cache up to the data that it knows has been received.

Client

FIGS. 2 and 3 show simplified examples of the program flow inside the driver. FIG. 2 shows the flow when a packet is received from the network (via the low-level hardware driver) and FIG. 3 showing the flow when a packet is received from the OS (to be sent to the network).

Receiving Packets from the Network

When a packet is received from the network, the port number is extracted and used to locate the storage area for that connection. If the SYN flag of a packet is set and no connection is currently set-up for the port number, the packet is merely forwarded to the OS.

Then a simple filter removes old packets that have already been received (as per TCP standard).

The next decision uses information gained from packets leaving the OS, being the last ACK value and window size from the OS. The decision forwards packets that will fit within the OS's view of the current connection's window.

When a packet is forwarded it is checked to see whether the FIN flag is set. If this is set, and if the list of non-zero packets is not empty, then a NACK packet is sent to the router. Also the sequence number and length of the forwarded packet are recorded in a store; then this store is cleared to remove any packets that were forwarded being less than the current sequence number minus the maximum window size.

If a packet is not forwarded to the OS, it is placed in a temporary store to extend the receive buffer size on the client. If this data store reaches, or exceeds, a certain level of occupancy on each packet added, the retry counter for the connection is incremented. When this retry counter hits a limit value, a NACK packet is transmitted to the router. If no packets are missing, an NACK packet is sent—this acts to throttle the router such that it forwards data at a lower rate.

Receiving Packets from the OS

A packet is associated with a particular connection. If the SYN option is set, then a new connection is initialised for this new connection. Options are taken from this SYN packet, such as the maximum segment size on the network.

The next test uses the value of the ACK in the previous packet received from the OS for this connection. If it is equal, and more data than that has been forwarded from the network, then this implies data is missing.

If no data is missing then the packet is forwarded, but only if it is not of zero length, or if it has any flags set.

When a packet is forwarded, a check is made to determine whether any data on the temporary packet store can be forwarded, up to the current available window size (as advertised in packet received from OS).

If data is missing, then the missing data is calculated and added to the missing packet list (if it is not already present). Occasionally, it will not be possible to determine exactly how many packets are lost (as with TCP, only the length of the missing data is known). However, an accurate approximation of this length can be made by taking the length of the missing data and fitting this into packets where the maximum size of these packets is the links maximum segment size.

If, when a missing packet is added to the missing packet list, that list is greater than a certain occupancy, the retry counter is incremented. If this retry counter is equal to one, or equal to a multiple of a set retry timeout value, a NACK packet is sent to the router.

NACK Packet

A NACK packet lists the data which is missing at the client. It therefore lists a number of sequence numbers and length values representing this missing data. It is up to the router to send this data in the required packets.

A NACK packet is also able to act as a warning to the router that it is sending the data faster than the application on the client is consuming it. This is achieved by placing, in the NACK packet, the last ACK sequence number of a packet coming from the OS. The router uses this information to calculate how fast it should send any further packets.

FIG. 4 shows packet and data flow in the driver. Packets from network and OS are filtered so that non-TCP packets are simply forwarded. TCP packets are analysed. Data is stored in areas which correspond to the connection that the packet belongs to.

Packet Flow Diagrams

FIGS. 5 to 7 show example packet flows for the system. Time flows down the diagram and each arrowed line represents a packet.

FIG. 5: Simple Example (Including One Lost Packet) Requesting a Web Page

FIG. 5 is split into four stages. Stage one shows the packet flow during the connection opening stage. As can be seen, the packets with the SYN flag set are forwarded. The router sends a packet (A1) back to the server after the second SYN flag as this is a zero length acknowledgement.

Stage 2 shows a non-zero length packet leaving the client. In a web example, this is the ‘GET’ command detailing the information required by the client.

Stage 3 shows a large amount of data (e.g. a web page or image) being streamed by the internet server S. These packets are forwarded by the router 10 and cached. After a certain number of packets (up to the window size reported by the client 16), the router creates a zero length ACK packet (A2) which it transmits to the internet server.

Note that Packet 13 is lost on the network between router 10 and the client 16. However, the router carries on receiving data and forwarding this.

Stage 4 shows the connection being closed. When the internet server S has finished sending the data, it sends a packet with the FIN flag set. The router 10 returns an acknowledgement packet, also with the FIN flag set to the server S, which closes the connection in the eyes of the server. The FIN packet is also forwarded to the client 16. On receiving this the client analyses what data is missing; if data is missing then a NACK packet (B1) is sent to the router. The router 10 then resends the requested data (which it has cached) in a new packet (B2); in this example, this has the same data as the missing packet P13. After receiving this missing data the client transmits an acknowledgement packet with the FIN flag set—when the router sees this information, it clears all information held for that connection (which is now closed).

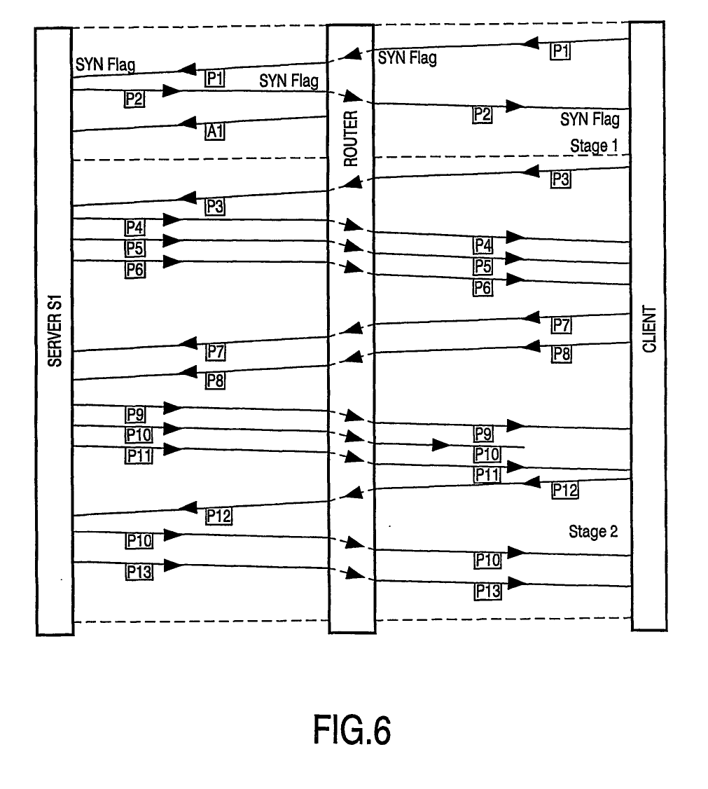

FIG. 6: Example of Two-Way Traffic

When the traffic is two-way, standard TCP allows for an efficient implementation to transmit ACK packets backwards and forwards. Hence, in this system, the system contains working in the traditional TCP manner.

In the diagram, packets travel in both directions. Apart from packet A1, there are no packets created by the router 10 to acknowledge received data.

Note that when a packet is lost (e.g. packet 10), the standard TCP mechanism of using an ACK value in a packet whose data length is not zero can be used to get the packet resent.

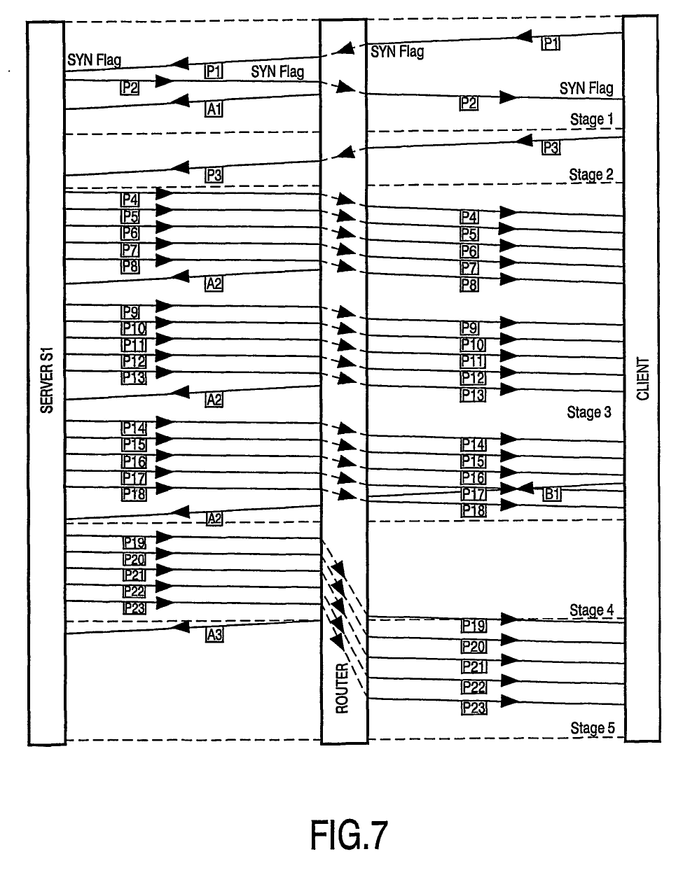

FIG. 7: Data Throttling

If data is simply forwarded through the router to the client 16, there is a high likelihood that the data will be sent faster than the client can deal with it. Therefore, the system needs to inform the router 10 to slow the rate that it sends packets to the client.

This is achieved by sending the current ACK value received from the OS to the router once the temporary data store exceeds a certain boundary.

FIG. 7 shows an example of this.

Stage 1 and stage 2 show standard opening of connection and request for data (as in FIG. 5).

Stage 3 shows a lot of data being sent by the server and forwarded to the client. If this data is arriving faster than the client is consuming the data, there comes a point when the temporary data store has reached a certain occupancy. At this point (just after packet 16 in our diagram), the client sends a NACK signal. In this example, no packets are missing; however, if the router was to continue forwarding packets at this rate, packets will be missed.

This NACK signal has the latest ACK value from the OS in it. This allows the router to calculate an approximate rate at which the client is consuming data. If the client is getting behind the router does not send any more packets to the client for a certain period (stage 4) at the end of this it will again start sending packets (stage 5), but with a larger time interval between each packet. Note that the input from the server, S, continues at the same rate as before (which is dictated by the internet server and the network between server and router).

Multiple Connection NACK Packets

In the current description NACK packets are sent on a per-connection basis. In a variant, when a NACK packet is sent, this represents the missing data for all open connections at that time.

This acts to further reduce the number of packets returning from the client (if it has multiple connections open).

Combined Internet Proxy Cache and Router

Systems currently exist which offer the ability to cache internet web pages, images etc. on servers. Such systems store these pages such that multiple clients on a network read the cached web pages from the internet cache, thereby reducing the load on the internet server.

These systems can be incorporated in the present invention, such that the router also becomes a proxy cache. The data received from the internet server is not thrown away at the end of the connection but is stored in the cache. If other clients require the same data, no connection between the internet server, S and the router/cache occurs, the data is streamed from the cache using the same protocol.

1. A method of routing data packets comprising receiving a plurality of data packets from a server, caching those data packets that are TCP/IP packets, transmitting said plurality of data packets to a client, and transmitting an acknowledgement of the receipt of said TCP/IP packets to said server.

2. A method according to claim 1, wherein the method further comprises retransmitting any cached TCP/IP packets upon request from the client.

3. A method according to claim 1 or 2 comprising, if no data or acknowledgement is received from the client, sending an acknowledgement to ensure that further data packets are sent to the router.

4. A method according to any preceding claim comprising accepting any negative acknowledgement packets from the client and resending the data packets from the data packet cache.

5. A method according to claim 4 comprising sending the missing data packets (i) when a connection has been closed and there are outstanding data packets; and/or
(ii) when the list of missing packets is full; and/or
(iii) when the data packet cache is nearly full.

6. A computer program product directly loadable into the internal memory of a digital computer, comprising software code portions for performing the steps of any one or more of claims 1 to 5 when said product is run on a computer.

7. A computer program for performing the steps of any one or more of claims 1 to 5 when said product is run on a computer.

8. Electronic distribution of a computer program product according to claim 6 or a computer program according to claim 7.

9. A system for routing data packets comprising a router for receiving and transmitting data packets and a client for receiving said data packets, said router arranged to cache those data packets that are TCP/IP packets and to transmit an acknowledgement of the receipt of said TCP/IP packets.

10. A system according to claim 9 wherein the router comprises means to retransmit any cached TCP/IP packets upon request from the client.

11. A system according to claim 9 or 10 wherein the router comprises means to send an acknowledgement to a server if no data or acknowledgement is received from the client, thereby to ensure that further data packets are sent to the router.

12. A system according to any of claims 9 to 11 wherein the router comprises receiving means to accept any negative acknowledgement packets from the client and transmitting means to resend the data packets from the data packet cache.

13. A system according to claim 12 wherein the transmitting means operates
(i) when a connection has been closed and there are outstanding data packets;
(ii) when the list of missing packets is full; and/or
(iii) when the data packet cache is nearly full.

14. Apparatus for transmitting data packets comprising receiving means for receiving a plurality of data packets, comprising receiving means for receiving a plurality of data packets, storage means for caching those data packets that are TCP/IP packets, and transmitting means for transmitting said data packets and for transmitting an acknowledgement of the receipt of said TCP/IP packets.

15. Apparatus according to claim 14 comprising means to retransmit any cached TCP/IP packets upon request from the client.

16. Apparatus according to claim 14 or 15 comprising means to send an acknowledgement to a server if no data packet or acknowledgement is received from a client, thereby to ensure that further data packets are sent to the router.

17. Apparatus according to claim 14 or 15 comprising means to accept any negative acknowledgement packets from the client and transmitting means to resend the data packets from the data packet cache.

18. Apparatus according to claim 17 wherein the transmitting means operates:
(i) when a connection has been closed and there are outstanding data packets;
(ii) when the list of missing packets is full; and/or
(iii) when the data packet cache is nearly full.

19. Apparatus for receiving data packets comprising receiving means for receiving data packets, processing means for identifying TCP/IP packets, storage means for storing a list of missing TCP/IP packets, and transmitting means for transmitting periodically said list of missing TCP/IP packets.

20. Apparatus according to claim 19, wherein the processing means is achieved in software, and communicates with the operating system of the apparatus.

21. Apparatus according to claim 19 or 20, wherein the transmitting means operates:
(i) when a connection has been closed and there are outstanding data packets; and/or
(ii) when the list of missing packets is full; and/or
(iii) when the data packet cache is nearly full.
